(19) United States
(12) Patent Application Publication
(10) Pub. No.: US 2020/0305360 A1
(43) Pub. Date: Oct. 1, 2020

(54) An Adjustable Nozzle For a Blower

(71) Applicant: HUSQVARNA AB, HUSKVARNA (SE)

(72) Inventor: Mathieu Lhoste-Clos, Charlotte, NC (US)

(21) Appl. No.: 16/651,628

(22) PCT Filed: Sep. 25, 2018
(86) PCT No.: PCT/EP2018/075887

§ 371 Date: Mar. 27, 2020

Related U.S. Application Data
(60) Provisional application No. 62/565,571, filed on Sep. 29, 2017.

(51) Int. Cl. A01G 20/47; E01H 1/08; B05B 1/00

(52) U.S. Cl. CPC A01G 20/47; B05B 1/3073; B05B 1/005; E01H 1/0809

(57) ABSTRACT

A portable leaf blower comprises a blower tube, comprising an adjustable nozzle portion (200) which is reconfigurable between an air speed mode, in which the nozzle portion (200) is configured to expel the air from the blower at a relatively higher air speed and a relatively lower volumetric flow rate, and an air volume mode, in which the nozzle portion (200) is configured to expel the air from the blower at a relatively lower air speed.

### TECHNICAL FIELD

Example embodiments relate generally to a blower and, more particularly, relate to an adjustable nozzle for a blower.

### BACKGROUND

Outdoor power equipment such as blowers (e.g., a leaf blower) may be an effective time saving tool for clearing debris from areas such as parking places, pavements, lawns, and footpaths. The clearing performance of the blower is traditionally measured in volumetric flow rate and air speed. The volumetric flow rate of a blower, which is typically measured in cubic feet per minute (CFM) or cubic meters per second (m³/s), relates to the volume of air that is configured to be expelled from the blower per unit time. The air speed of the blower, which is typically measured in miles per hour (MPH) or meters per second (m/s), relates to the speed of the air as the air is expelled from the blower.

Traditionally, a blower has a maximum volumetric flow rate and a maximum air speed at which the blower is configured or able to perform. However, the blower is not generally configured to operate at both the maximum volumetric flow rate and the maximum air speed at the same time. Rather, a blower may include a plurality of removable, interchangeable nozzles that are designed to either ensure the blower is operating near or at its maximum volume or speed. In other words, a blower may have a first nozzle that is configured to enable the blower to perform at its maximum volumetric flow rate, and a second nozzle that is configured to enable the blower to perform at its maximum air speed. Thus, depending on the clearing performance of the blower desired by a user of the blower, the user of the blower must ensure that the nozzles are kept with the blower during operation of the blower and switch the nozzles depending on the performance desired.

### BRIEF SUMMARY OF SOME EXAMPLES

Some example embodiments may therefore provide an adjustable nozzle for a blower. The adjustable nozzle may be configured to operate in one of a plurality of modes such as an air volume mode or an air speed mode. For example, the nozzle may be configured to be rotated by the user to transition between the air volume mode and the air speed mode. Accordingly, the adjustable nozzle limits the parts or additional accessories needed to operate the blower and provides for a simple, efficient manner to maximize the clearing performance of the blower.

In accordance with an example embodiment, a blower may be provided. The blower may include a housing and a motor disposed within a portion of the housing to selectively operate a fan assembly. The blower may further include a blower tube through which air is forced responsive to operation of the motor. The blower tube may include a body portion and a nozzle portion operably coupled to the body portion of the blower tube. The nozzle portion may be configured to expel the air from the blower in one of a plurality of modes, the plurality of modes comprising an air speed mode and an air volume mode.

In another example embodiment, a nozzle portion for a blower is provided. The nozzle portion may be configured to expel air from the blower in one of a plurality of modes, the plurality of modes including an air speed mode and an air volume mode, The nozzle portion may include a first tube and a second tube, The first tube may be coupled to a portion of an exterior surface of the second tube, and one of the first tube or the second tube may be translated relative to the other of the first tube or the second tube in order to transition between the air volume mode and the air speed mode. The nozzle portion may be configured in accordance with any of the embodiments defined hereinbelow.

According to one aspect, there is provided a portable leaf blower comprising a housing; a motor disposed within a portion of the housing to selectively operate a fan assembly; and a blower tube connected to the fan to receive air forced through the blower tube responsive to operation of the motor, the blower tube comprising an adjustable nozzle portion which is reconfigurable between an air speed mode, in which the nozzle portion is configured to expel the air from the blower at a relatively higher air speed and a relatively lower volumetric flow rate, and an air volume mode, in which the nozzle portion is configured to expel the air from the blower at a relatively lower air speed and a relatively higher volumetric flow rate, wherein said relatively higher air speed is higher than said relatively lower air speed, and said relatively higher volumetric flow rate is higher than said relatively lower volumetric flow rate.

According to an embodiment, the nozzle portion may comprise a first tube and a second tube, wherein one of the first tube and the second tube is configured to be translated relative to the other of the first tube and the second tube in order to transition between the air volume mode and the air speed mode. The first tube may be an outer tube, and the second tube may be an inner tube arranged within the outer tube. Each of the first and second tube may be integrally formed as a respective rigid, unitary component. According to an embodiment, the first tube may be movable relative to the housing with the fan assembly, whereas the second tube may be fixedly positioned relative to the housing with the fan assembly.

According to an embodiment, the second tube may extend along a tube axis; the first tube encloses the second tube; and the first and second tubes are movable, and in particular, translatable, in relation to each other along said tube axis.

According to an embodiment, at least one of the first tube and the second tube may comprise a tapering tube portion such that, when axially moving the first and second tubes in relation to each other, a radial, with respect to said tube axis, gap between the first and second tubes changes at said tapering tube portion. The tapering tube portion may, for example, taper towards the blower outlet.

According to an embodiment, each of the first tube and the second tube may comprise a respective tapering tube portion, wherein the respective tapering tube portions are in register with each other and taper towards the same axial direction. Such a geometry facilitates a laminar air flow along the nozzle portion.

According to an embodiment, the blower may further comprise a locking arrangement for locking the position of the second tube relative to the first tube. The tubes may be configured to be axially lockable to each other at a plurality of distinct axial positions. Alternatively, the locking arrangement may be configured to axially interlock the tubes at any position to allow a stepless transition between the air speed and air volume modes.

According to an embodiment, the first tube may be rotatably coupled to the exterior surface of the second tube to be rotatable about a tube axis between an axially locked position and an axially released position.

According to an embodiment, the nozzle portion may be configured such that, during the air volume mode, the air is configured to be expelled from an outlet portion of the first tube and an outlet portion of the second tube, and during the air speed mode, the outlet portion of the first tube is at least partly closed. The second tube may be movable in relation to the first tube such that the second tube to a reconfigurable and user-selectable extent blocks the outlet portion of the first tube.

According to an embodiment, the nozzle portion may be configured such that, wherein in the air volume mode, the outlet portion of the first tube extends over the outlet portion of the second tube at a distance that enables the air to be expelled from the outlet portion of the first tube and the outlet portion of the second tube. For example, the outlet portions of the first and second tubes may, when in air volume mode, define an annular gap between them. When in air speed mode, the annular gap may be closed, such that substantially all air is forced through the outlet portion of the second tube.

According to an embodiment, the first tube may comprise a head portion and a body portion, and the second tube may comprise a head portion, a body portion, and a shoulder portion, the shoulder portion comprising an opening, wherein the diameter of the head portion of the second tube is smaller than the diameter of the head portion of the first tube to enable a portion of the air to pass through the opening of the shoulder portion and move around an exterior surface of the second tube to be expelled from the outlet of the first tube.

According to an embodiment, the nozzle portion may be configured such that, in order to transition the nozzle portion from the air volume mode to the air speed mode, either of the first tube or the second tube is translated to enable the outlet portion of the second tube to extend out of the outlet portion of the first tube at a distance to seal off the outlet portion of the first tube such that the air is configured to be expelled only from the outlet portion of the second tube.

According to an embodiment, the first tube and the second tube may each comprise a head portion and a body portion, wherein the head portion of the second tube is a prolate spheroid shape configured to enable the outlet portion of the second tube, when in air speed mode, to extend axially out of the outlet portion of the first tube. Such a shape enables a high air speed, and by extending out of the first tube, allows holding the outlet portion of the second tube in close proximity to the debris to be blown.

According to an embodiment, one of the first tube and the second tube may comprise at least one grooved portion, the other of the first tube and the second tube may comprise at least one projection, and the at least one projection may be disposed in the at least one grooved portion to enable a translation of the first tube or the second tube relative to the other of the first tube or the second tube.

According to an embodiment, the grooved portion may comprise a first groove section extending mainly along a longitudinal direction of the nozzle portion to allow axial translation of the first and second tubes relative to each other, and a second groove section extending mainly in a circumferential direction, to allow rotation of the first and second tubes relative to each other in order to axially lock them together. Multiple second groove sections, extending in the circumferential direction, may be arranged to extend from the first groove section at different axial positions thereof, to allow axially interlocking the first and second tubes at a plurality of different axial positions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a side view of a blower having a nozzle in accordance with an example embodiment;

FIG. 2 illustrates a perspective view of a first tube of a nozzle in accordance with an example embodiment;

FIG. 3 illustrates a perspective view of a second tube of a nozzle in accordance with an example embodiment;

FIG. 4 illustrates a perspective view of a nozzle in an air volume mode in accordance with an example embodiment;

FIG. 5 illustrates a perspective view of a nozzle in an air volume mode in accordance with an example embodiment;

FIG. 6 illustrates a cross-sectional view of a nozzle in an air volume mode in accordance with an example embodiment;

FIG. 7 illustrates the air flow through a nozzle in an air volume mode in accordance with an example embodiment;

FIG. 8 illustrates a perspective view of a nozzle in an air speed mode in accordance with an example embodiment;

FIG. 9 illustrates a perspective view of a nozzle in an air speed mode in accordance with an example embodiment;

FIG. 10 illustrates a cross-sectional view of a nozzle in an air speed mode in accordance with an example embodiment; and

FIG. 11 illustrates a cross-sectional view of a nozzle in an air speed mode in accordance with a further example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein provide for an adjustable nozzle for a blower. The nozzle may be configured to operate in one of a plurality of modes such as an air volume mode or an air speed mode. Accordingly, the blower does not require a user to switch between a plurality of removable nozzles to change modes. Rather, the adjustable nozzle may be configured to stay operably coupled to a blower tube of the blower and may be adjusted between a plurality of modes based on the desired clearing performance. Accordingly, the nozzle described herein provides for simple, efficient manner to maximize the clearing performance of the blower.

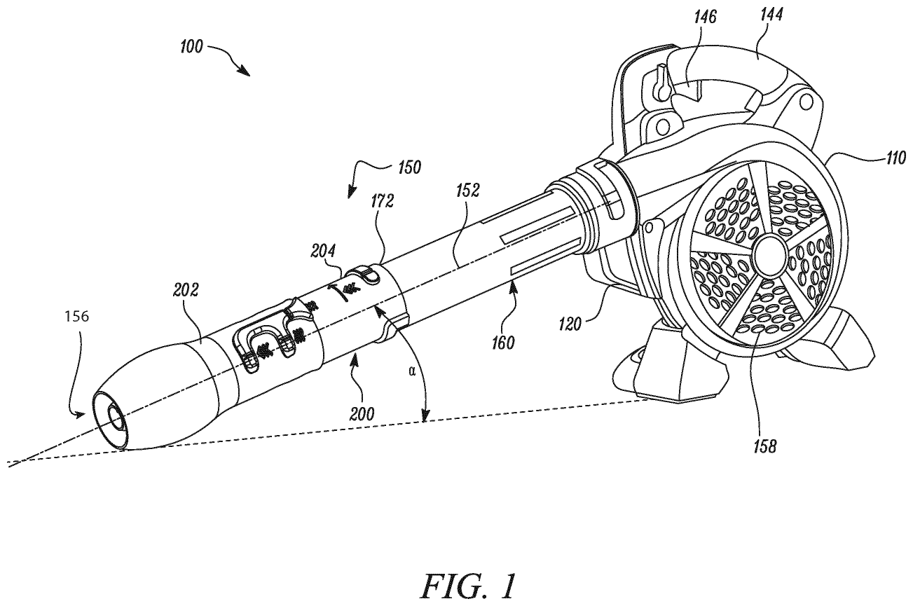

FIG. 1 illustrates a side view of a portable leaf blower 100 in accordance with an example embodiment. It should be appreciated that the blower 100 of FIG. 1 merely represents one example of a blower 100 on which an example embodiment may be employed. It should be understood, however, that other blower designs may also practice example embodiments. Referring to FIG. 1, the blower 100 may include a housing 110 inside which various components of the blower 100 are housed. The blower 100 may further include a motor housing portion 120 inside which a motor or power source for providing the driving force to move air through the blower 100 is housed. In some embodiments, the motor or power source may be a gas-powered, corded electric, or a battery-powered motor or power source. Furthermore, the motor or power source may be operated under the control of a control unit or control circuitry. The housing 110 may be formed of plastic, composite materials, metals, or any other desirable materials. In an example embodiment, the housing 110 may be formed of two or more molded pieces that can be fit together. In some cases, the molded pieces may form half-shells (e.g., right and left half-shells) that can be affixed to each other via welding, adhesives, snap fittings, fixing members (e.g., screws), or the like. When the molded pieces are fit together, the molded pieces may form a seam at the location of joining between the molded pieces.

In some embodiments, the control unit may be housed in its own portion of the housing 110. The portion of the housing 110 in which the control unit is housed may be referred to as a control unit housing portion (not shown), and the control unit housing portion may be an integral part of a half-shell (as described above) or may be a separate housing portion that is joined to other housing portions. The control unit housing portion may be disposed proximate to a portion of the housing 110 near which the motor is provided.

The blower 100 may further include a handle 144. The handle 144 may be configured for carrying the blower 100 with one hand, and may include a trigger 146 that may be operated by a finger of the operator while the operator holds the handle 144. Actuation of the trigger 146 may cause power from the power source to be selectively applied to the motor to turn the motor based on control provided by the control unit. In some cases, the control unit may include interlocks, protective functions or other control mechanisms that may sense various conditions of the blower 100 via sensors, switches or other mechanisms in order to selectively control the application of power to the motor based on indications of user intent (e.g., via actuation of the trigger 146) or determinations regarding the state of the blower 100 as provided by the sensors, switches, or other mechanisms.

It should be appreciated that although FIG. 1 shows an example in which the trigger 146 is used for selective powering of the motor, other example embodiments may employ a selector, switch, button, or other such operative member in order to selectively control operation of the motor. Thus, for example, on/off, speed control or other operable functions for controlling the motor may be performed using an operative member of any desirable form, and the trigger 146 is just one example.

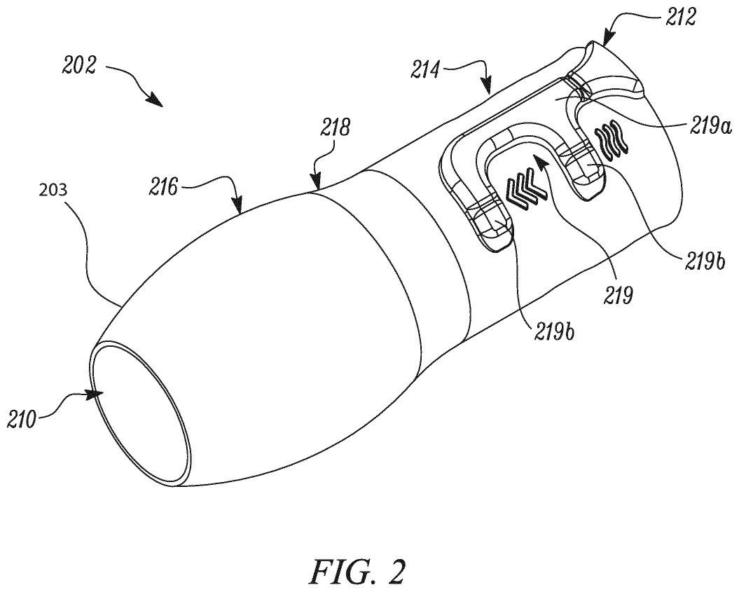

The blower 100 may further include a blower tube 150 that may be attached to the housing 110 (or is a part of the housing 110) and through which air may be expelled. The blower tube 150 may define a blower tube axis 152, which defines an axial centerline of the blower tube 150. The blower tube 150 may include an inlet portion and an outlet 156 (as further described below in relation to FIGS. 2-11). The outlet 156 may be at a distal end of the blower tube 150 and the inlet portion may be at an opposite end of the blower tube 150 proximate to the motor and the power source.

In an example embodiment, the inlet portion may be disposed proximate to an aperture array 158 including louvers, vanes, guide holes, or other such apertures formed in the housing 110 to enable air to enter into the blower tube 150 responsive to operation of the motor to be expelled via the outlet. In this regard, the operation of the motor may cause an impeller or fan assembly to rotate so that a low pressure area is generated to draw air into the inlet portion through the aperture array 158 to be passed through the fan assembly and expelled from the blower tube 150 at the outlet to blow leaves, debris, or any other material. In some cases, the motor and the fan assembly may each be coaxial with the blower tube axis 152, so that air exiting the fan assembly is generally moved (although such flow may be turbulent) along a direction substantially parallel to the blower tube axis 152. As shown in FIG. 1, the blower 100 may be designed for balance and optimal ergonomics while being operated. As such, the handle 144 may be generally designed to extend substantially horizontal to the ground plane while the operator holds the blower 100 in a natural or comfortable grip, with the blower's 100 center of gravity vertically below the handle 144. Meanwhile, the blower tube axis 152 lies at an angle α relative to the ground plane. The angle α may be between 15 degrees and 35 degrees in some embodiments, and could be selected based on balancing the centers of mass of the various components of the blower 100, while also generating a natural downward cant angle that generally points the outlet 156 toward the ground when the blower 100 is held in its most comfortable and natural position by the operator. Accordingly, while the operator is standing normally and holding the blower 100 by the handle 144, the outlet of the blower tube 150 may be proximate to the ground to enable the air expelled therefrom to perform the desired function of blowing leaves or other debris.

In order to place the outlet of the blower tube 150 proximate to the ground, but still enable the blower 100 to be made more compact for storage or packaging, the blower tube 150 may be structured to include two portions that can be easily and removable coupled to each other. In this regard, a base portion 160 of the blower tube 150 may be provided to be fixed to the housing 110 at a proximal end thereof. Meanwhile, a nozzle portion 200 may be provided to be removably attachable to a distal end of the base portion 160. The nozzle portion 200 and the base portion 160 may be operably coupled to each other via a fixation area 172 at which contact between the nozzle portion 200 and the base portion 160.

In an example embodiment, the base portion 160 and the nozzle portion 200 may overlap each other at a portion of the distal end of the base portion 160 and a portion of the proximal end (relative to the housing 110) of the nozzle portion 200, as further described below. The overlap region may be formed by having one of the base portion 160 or the nozzle portion 200 configured as a male end and having the other of the base portion 160 or the extension portion configured as a female end into which the male end is inserted. In the example of FIG. 1, the base portion 160 is configured as the male end and the nozzle portion 200 is configured as the female end. However, the base portion 160 could be configured as the female end and the nozzle portion 200 could be configured as the male end in an alternative embodiment.

In some embodiments, the region of overlap of the base portion 160 and the nozzle portion 200 may define the fixation area 172. The fixation area 172 may define a point or points of contact between the base portion 160 and the nozzle portion 200 that facilitate fixation of the base portion 160 to the nozzle portion 200.

In accordance with an example embodiment, the blower 100 may further include the multi-mode, reconfigurable nozzle portion 200 shown and described in FIGS. 2-11. The nozzle portion 200 may be operably coupled to the base portion 160 of the blower tube 150 as described above. Accordingly, air may be expelled through the nozzle portion 200 of FIGS. 2-11. The nozzle portion 200 described herein may be configured to be operated in a plurality of modes based on the clearing performance desired by the user of the blower 100. The modes may include, for example, an air volume mode or an air speed mode. As mentioned above, air expelled from the nozzle portion 200 may be measured based on the speed (MPH) or the volume (CFM) at which the air exits the blower 100. For example, if the blower 100 has a speed rating of 120 then 120 MPH is the speed at which the air exits the outlet 156 of the blower tube 150 or nozzle portion 200. Furthermore, if the blower 100 has a CFM rating of 90, then every minute the blower 100 is in use, 90 cubic feet of air may exit the outlet 156 of the blower tube 150 or nozzle portion 200. Typically, if the blower 100 is operated at its maximum volumetric flow rate, then the blower 100 cannot also be operated at its maximum air speed. Traditionally, to control the performance of the blower 100, the volume and speed that the blower 100 operates at may be controllable by separate removable nozzles. In other words, if the operator wishes to operate the blower 100 at a maximum velocity or speed then the operator must attach a first nozzle to the outlet 156 of the blower tube 150, and if the operator wishes to operate the blower 100 at a maximum volume, then the operator must take off the first nozzle and attach a second nozzle to the outlet 156 of the blower tube 150.

Example embodiments provided herein therefore may provide for one nozzle portion 200 that may be adjustable to operate in one of the plurality of modes (e.g., an air volume mode or an air speed mode). Accordingly, the operator will not have to interchange different nozzles based on the desired clearing performance of the blower 100. Thus, the adjustable nozzle portion 200 provided herein may provide for a more streamlined, simplified manner of operating the blower 100.

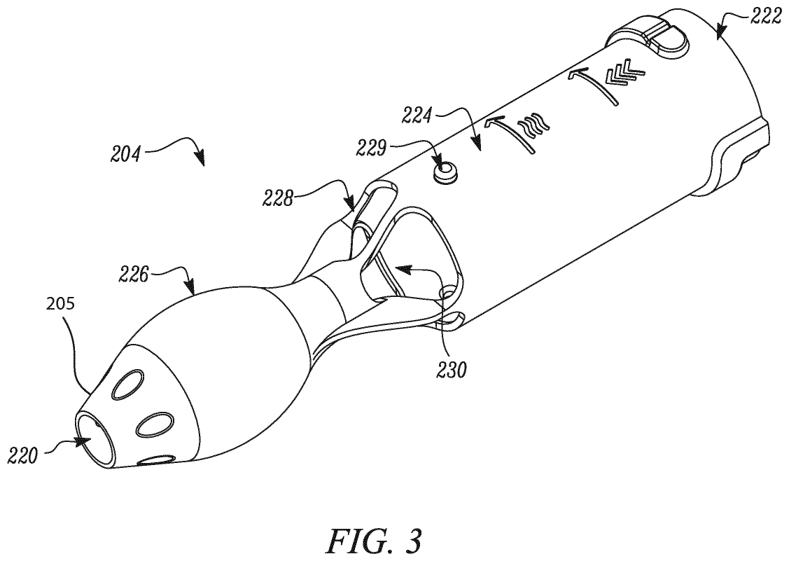

As further shown in FIG. 1, the nozzle portion 200 may be operably coupled to the base portion 160 of the blower tube 150. The nozzle portion 200 may include a first tube 202 operably coupled to a second tube 204. In some cases, the first tube 202 may be operably coupled to an exterior surface of the second tube 204. Accordingly, the first tube 202 may be an outer tube in relation to the second tube 204, and the second tube 204 may be an inner tube in relation to the first tube 202. The first tube 202 and the second tube 204 may each have an inlet portion 212 (FIG. 2), 222 (FIG. 3) and an outlet portion 210 (FIG. 2), 220 (FIG. 3). The first tube 202 and the second tube 204 may each be one molded piece. However, in other example embodiments, each of the first tube 202 and the second tube 204 may be formed of two or more molded pieces that can be fit together via welding, adhesives, snap fittings, fixing members, or the like.

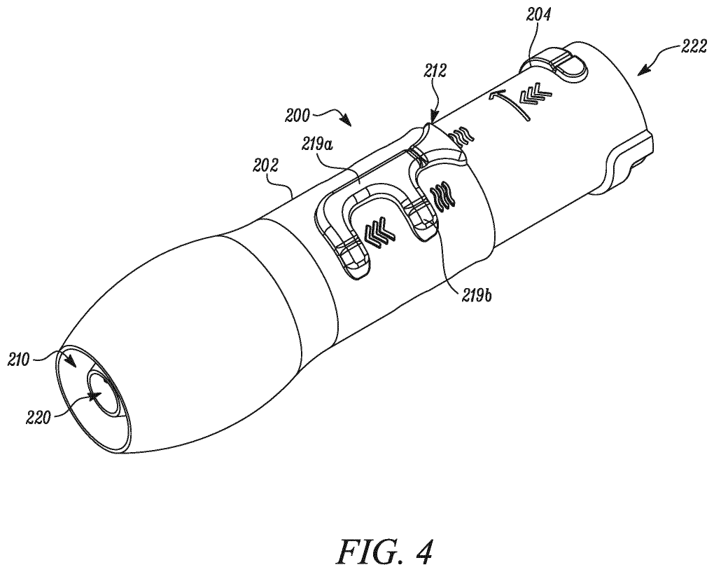

The inlet portion 222 of the second tube 204 may be operably coupled to the base portion 160 of the blower tube 150. Furthermore, the inlet portion 212 of the first tube 202 may be operably coupled to a portion of the second tube 204 (see FIG. 4), such as to an outer face of the second tube 204. In accordance with other example embodiments, however, the inlet portion 212 of the first tube 202 may be operably coupled to the base portion 160 of the blower tube 150, and the inlet portion 222 of the second tube 204 may be operably coupled to a portion of an interior surface of the first tube 202.

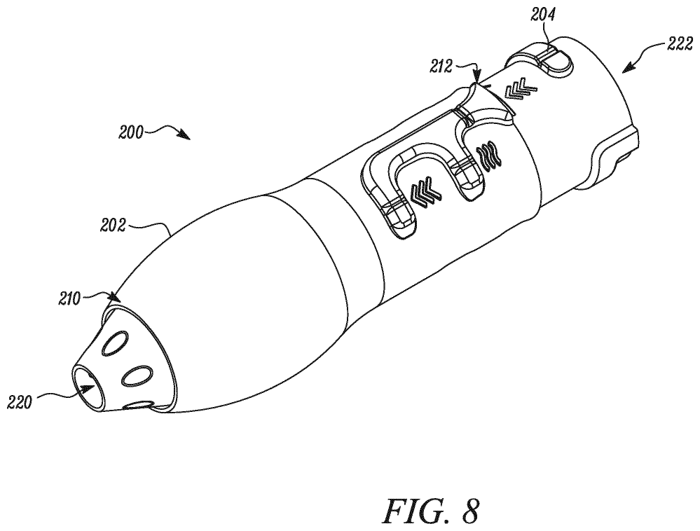

In accordance with an example embodiment, the first tube 202 and the second tube 204 may be translatable relative to one another in order to adjust the nozzle portion 200 between the plurality of clearing modes. For example, the first tube 202 and the second tube 204 may be translatable between an air volume mode (see FIGS. 3-6) and an air speed mode (see FIGS. 8-11). In some cases in order to translate the first tube 202 and the second tube 204 between the plurality of modes, the second tube 204 may be translated and rotated in one direction (e.g., clockwise) relative to the first tube 202 to move the second tube 204 forward (i.e., toward the outlet portion 210 of the first tube 202), and the second tube 204 may be translated and rotated in the opposite direction (e.g., counterclockwise) relative to the first tube 202 to move the second tube 204 backward (i.e., toward the inlet portion 212 of the first tube 202) within the first tube 202. It should be understood, however, that the first tube 202 may be configured to translate and rotate in a similar manner relative to the second tube 204 in order to adjust the nozzle portion 200 between the plurality of clearing modes.

FIG. 2 illustrates a perspective view of the first tube 202 of the nozzle portion 200 in accordance with an example embodiment. As shown in FIG. 2, the first tube 202 may include a body portion 214 and a head portion 216. In some cases, the head portion 216 may taper into the body portion 214 (e.g., a shoulder portion 218 may be disposed between the head portion 216 and the body portion 214). In this regard, the body portion 214 may have a substantially uniform diameter, and at least a portion of the head portion 216 may have a larger diameter than the body portion 214 of the first tube 202. The first tube 202 may further comprise a tapering portion 203, which tapers towards the outlet of the first tube 202.

The first tube 202 may further include at least one grooved portion 219. Accordingly, while FIG. 2 demonstrates only one grooved portion 219, other example embodiments may include a plurality of grooved portions 219. A raised portion of the grooved portion 219 shown on the exterior surface of the first tube 202 may form a corresponding groove or channel in the interior surface of the first tube 202. The grooved portion 219 may be configured to interface with a portion of the second tube 204 to control the translation or rotation of the first tube 202 relative to the second tube 204 or vice versa. In other words, the grooved portion 219 may limit an amount the operator may translate or rotate the first tube 202 in the clockwise or counter clockwise direction. As shown in FIG. 2, the grooved portion 219 may include a first section 219a that extends longitudinally along a portion of the first tube 202. Furthermore, the grooved portion 219 may include at least one instance of second section 219b that extends perpendicularly from the first section.

FIG. 3 illustrates a perspective view of the second tube 204 of the nozzle portion 200 in accordance with an example embodiment. As shown in FIG. 3, the second tube 204 may include a body portion 224 and a head portion 226. In some cases, the body portion 224 may taper into the head portion 226 (e.g., a shoulder portion 228 may be disposed between the head portion 226 and the body portion 224). In this regard, the body portion 224 may have a substantially uniform diameter, and at least a portion of the head portion 226 may have a diameter smaller than the diameter of the body portion 224. The second tube 204 may further comprise a tapering portion 205, which tapers towards the outlet of the second tube 204.

The head portion 226 may have the general shape of an American football (i.e., a prolate spheroid shape), and opened at both longitudinal ends to allow air to pass therethrough. Furthermore, the shoulder portion 228 may include at least an opening 230 to enable air flow through the second tube 204 as described in more detail below. In the illustrated case, the shoulder portion 228 has three such openings 230. In some cases, at least a portion of the diameter of the body portion 224 of the second tube 204 may be smaller than the diameter of the body portion 214 of the first tube 202, and at least a portion of the diameter of the head portion 226 of the second tube 204 may be smaller than the diameter of the head portion 216 of the first tube 202. It should be understood, however, that the body portion 224 and the head portion 226 of the second tube 204 may be shaped and sized in manner such that they fit within the inner diameter of the first tube 202 and enable air flow through the nozzle portion 200 as described in more detail below.

In some cases, the diameter of the outlet portion 220 of the second tube 204 may be configured to be smaller than the diameter of the outlet portion 210 of the first tube 202. Furthermore, at least one projection 229 may be disposed on or operably coupled to an exterior surface of the second tube 204. The projection 229 may be configured to fit within or move within the grooved portion 219 of the first tube 202. The interaction of the projection 229 in the grooved portion 219 may be configured to operably couple the first tube 202 and the second tube 204 while controlling the rotation of the first tube 202 relative to the second tube 204 or vice versa. The projection 229 may be any shape or size to enable the projection to be disposed in the grooved portion 219. For example, referring to FIG. 4, in order to hold the first tube 202 and the second tube 204 in a mode or position, the projection 229 may be rotated into one of the second sections 219b. However, in order to translate or rotate the first tube 202 and the second tube 204 to a different mode or position, one of the first or second tubes 202, 204 may be rotated such that the projection 229 moves out of one of the second sections 219b into the first section 219a of the grooved portion 219 and then is translated in a forward or rearward movement in order to move the projection 229 in line with an opening of one of the other second sections 219b and then rotated into that second section 219.

It should be understood that the projection 229 and the grooved portion 219 described above are an example embodiment described herein to couple and limit the movement or rotation of the first tube 202 and the second tube 204. In accordance with other example embodiments, the grooved portion 219 may be disposed on the base portion 160 of the blower tube 150 in instances where the inlet portion 212 of the first tube 202 may be operably coupled to the base portion 160 of the blower tube 150, for example.

Furthermore, other mechanisms or assemblies may be used to couple or limit the movement or rotation of the first tube 202 and the second tube 204. For example, a biasing mechanism such as a spring may be used. Furthermore, it should be understood that the projection 229 may be located on the first tube 202, and the grooved portion 219 may be located on the second tube 204. Alternatively, neither the first tube 202 nor the second tube may include an assembly or mechanism (e.g., grooved portion and projection) to couple the first tube 202 or the second tube 204, but rather the shapes and sizes of the first tube 202 and the second tube 204 and how they are positioned to fit into one another may serve to couple the first tube 202 and the second tube 204.

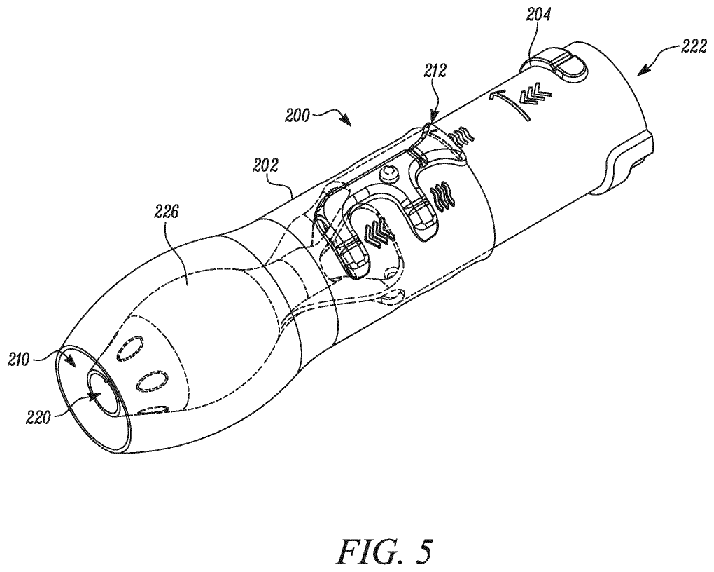

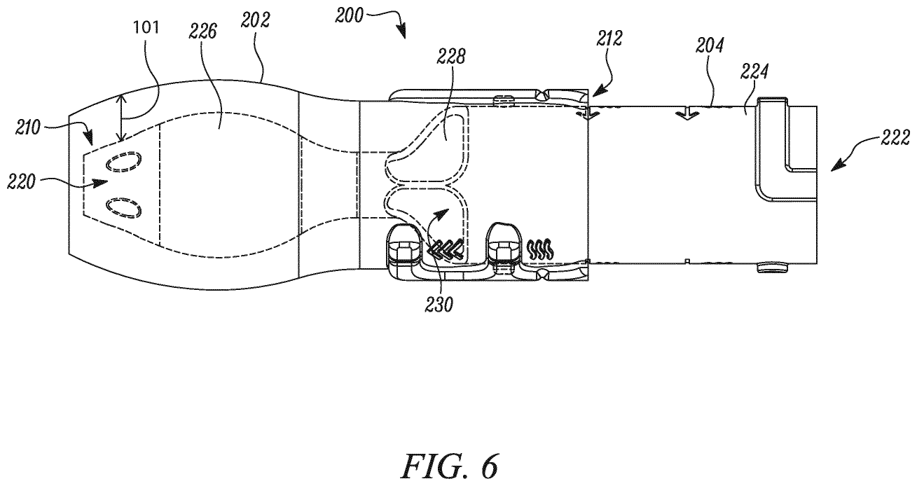

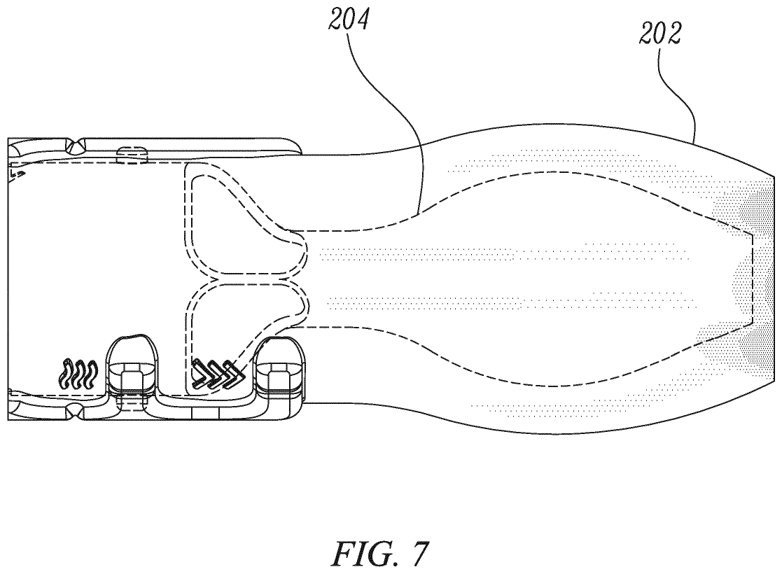

FIGS. 4-7 illustrate example embodiments of the nozzle portion 200 in the air volume mode. In this regard, FIGS. 4 and 5 illustrate a perspective view of the nozzle portion 200 in the air volume mode in accordance with an example embodiment. FIG. 6 illustrates a cross-sectional view of the nozzle portion 200 in the air volume mode in accordance with an example embodiment. FIG. 7 illustrates the air flow through the nozzle portion 200 in the air volume mode in accordance with an example embodiment, wherein a darker shade represents a higher air speed.

As shown in FIGS. 4-7, when the nozzle portion 200 is positioned in the air volume mode, the head portion 226 of the second tube 204 may be disposed within the interior of the first tube 202. Air blown from the blower tube 100 will flow first through the body portion 224 of the second tube 204. As the air reaches the shoulder portion 228 of the second tube 204, a portion of the air may go through or be forced through the head portion 226 of the second tube 204 to exit the nozzle portion 200 via the outlet portion 220 of the second tube 204, and a portion of the air may go through or be forced through the openings 230. The portion of the air that goes through the openings 230 will be directed around an exterior surface of the head portion 226 to exit the nozzle portion 200 via the outlet portion 210 of the first tube 202. Accordingly, the head portion 226 of the second tube 204 may be any shape that enables air to flow around the exterior of the head portion 226 such that the air may also flow through the outlet portion 210 of the first tube 202. Thus, when the nozzle portion 200 is positioned in the air volume mode, air may be directed out of the outlets 210, 220 of both the first tube 202 and the second tube 204. In other words, when the outlet portion 220 of the second tube 204 is disposed entirely in the interior of the first tube 202, the nozzle portion 200 may be configured to operate in the air volume mode. Therefore, it should be understood that when the nozzle portion 200 is in the air volume mode, the nozzle portion 200 utilizes the outlets 210, 220 of both the first tube 202 and the second tube 204 to expel the maximum volumetric flow rate from the blower 100. Accordingly, when the nozzle portion 200 is in the air volume mode, coaxial air columns may exist. For example, a first air column may be formed through the head portion 226 of the second tube 204, and a second air column may be formed around the head portion 226 of the second tube 204 yet within the first tube 202. The air columns may only be separated by the surface of the head portion 226 of the second tube 204 and then grouped together as the air leaves the nozzle portion 200.

FIG. 6 illustrates a radial gap 101 between the first and second tubes 202, 204. When moving the first and second tubes 202, 204 in relation to each other along the center axis 152 (FIG. 1), the size of the radial gap 101 changes.

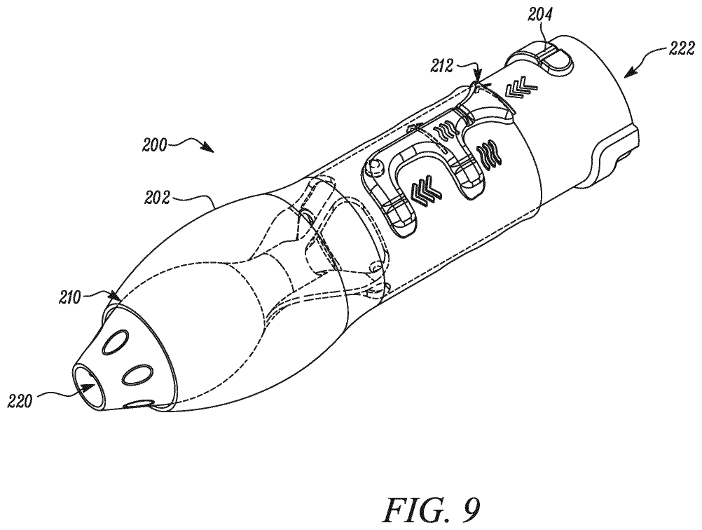

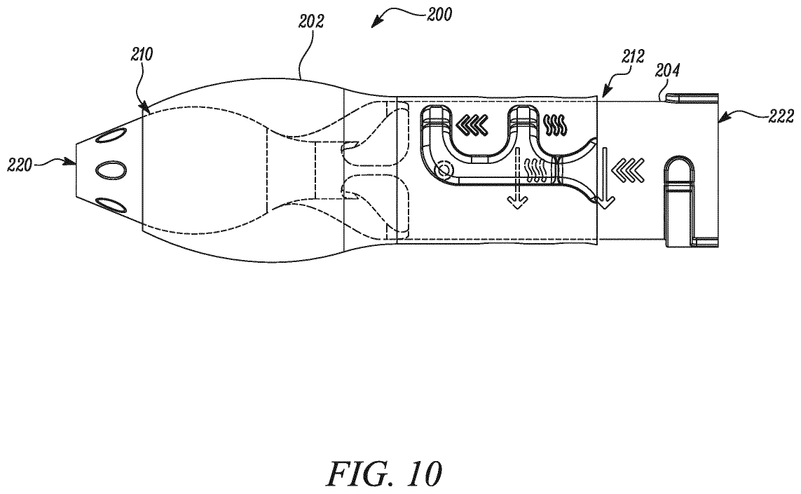

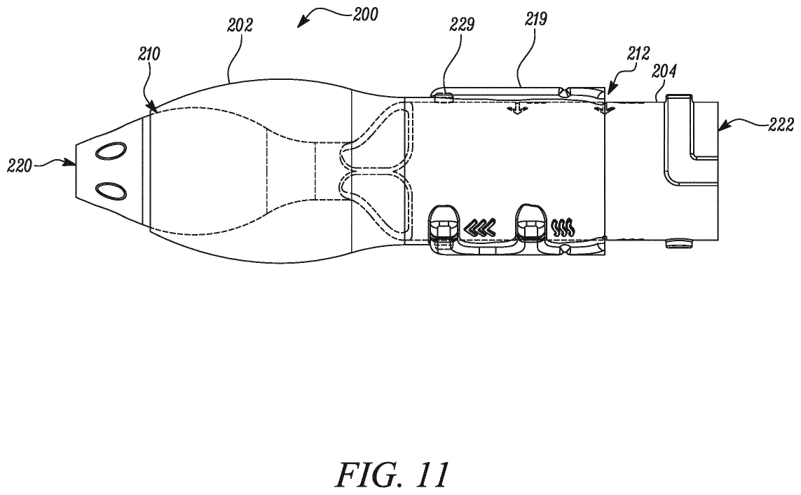

FIGS. 8-11 illustrate example embodiments of the nozzle portion 200 in the air speed mode. In this regard, FIGS. 8 and 9 illustrate a perspective view of the nozzle portion 200 in the air speed mode in accordance with an example embodiment. FIGS. 10 and 11 illustrate cross-sectional views of the nozzle portion 200 in the air speed mode in accordance with example embodiments.

As shown in any of FIGS. 8-11, in order to transition the nozzle portion 200 from the air volume mode to the air speed mode, the second tube 204 may be translated in a direction toward the outlet 210 of the first tube 202 such that the outlet portion 220 of the second tube 204 extends through and past the outlet portion 210 of the first tube 202. It should be understood, however, that in some cases in order to transition the nozzle portion 200 to the air speed mode, the first tube 202 may be translated toward the inlet portion 222 of the second tube 204 such that the outlet portion 220 of the second tube 204 extends through and past the outlet portion 210 of the first tube 202. In other words, one of the first tube 202 or the second tube 204 may be translated relative to the other until an interior surface of the head portion 216 comes into contact with an exterior surface of the head portion 226 of the second tube 204 substantially cutting off any airflow therebetween. Furthermore, in embodiments where the nozzle portion 200 includes the grooved portion 219 and corresponding projection 229, the projection 229 of the second tube 204 may have correspondingly translated and rotated. For example, in order to transition the nozzle portion 200 from the air volume mode to the air speed mode, the projection 229 may first rotate out of the second sections 219b disposed proximate the inlet portion 212 of the first tube 202 toward a longitudinal centerline of the nozzle portion 200 and then be translated along the first section 219a of the grooved portion 219 toward the outlet 210 of the first tube 202 to line up with an opening of the second section 219b disposed closer to the outlet portion 210 and then rotated away from the longitudinal centerline of the nozzle portion into the second section 219b of grooved portion 219 disposed closer to the outlet portion 210 to lock the second tube 204 into engagement with the first tube 202.

When either the first tube 202 or the second tube 204 is translated or rotated relative to the other to be positioned in the air speed mode, a portion of the head portion 226 of the second tube 204 may seal off the outlet portion 210 of the first tube 204 so substantially no air may escape from the outlet portion 210 of the first tube 202. Accordingly, air from the outlet 156 of the blower tube 150 may be expelled through only the outlet portion 220 of the second tube 204 when the nozzle 220 is in the air speed mode. By forcing the air though only the outlet 220 having the smaller diameter, the speed of the air as the air exits the nozzle 220 is maximized.

In accordance with a further example embodiment, the nozzle portion 200 may be adjustable to other modes in addition to the air volume mode to the air speed mode. In other words, the nozzle portion 200 may be adjustable to positions between the air volume mode and the air speed mode described above. For example, the second tube 204 may be translated in a direction toward the outlet 210 of the first tube 202 such that the outlet portion 220 of the second tube 204 extends through and past the outlet portion 210 of the first tube 202 while only limiting the amount of air flow flowing out of the outlet 210 of the first tube 202 without entirely cutting off any airflow. Accordingly, it should be understood that the nozzle portion 200 may include the grooved portion 219 or corresponding first or second sections 219a and 219b of the grooved portion 219 that enable the head portion 226 of the second tube 204 to only partially extend through the head portion 216 of the first tube 202.

Accordingly, a blower may be provided. The blower may include a housing and a motor disposed within a portion of the housing to selectively operate a fan assembly. The blower may further include a blower tube through which air is forced responsive to operation of the motor. The blower tube may include a body portion and a nozzle portion operably coupled to the body portion of the blower tube. The nozzle portion may be configured to expel the air from the blower in one of a plurality of modes, the plurality of modes comprising an air speed mode and an air volume mode.

In some embodiments, additional optional structures or features may be included or the structures/features described above may be modified or augmented. Each of the additional features, structures, modifications, or augmentations may be practiced in combination with the structures/features above or in combination with each other. Thus, some, all or none of the additional features, structures, modifications, or augmentations may be utilized in some embodiments. Some example additional optional features, structures, modifications, or augmentations are described below, and may include, for example, that the nozzle portion may include a first tube and a second tube, where the first tube may be operably coupled to a portion of an exterior surface of the second tube, and where one of the first tube or the second tube may be translated relative to the other of the first tube or the second tube in order to transition between the air volume mode and the air speed mode. Alternatively or additionally, the first tube and the second tube may each include an inlet portion and an outlet portion, where the inlet portion of the second tube may be operably coupled to the body portion of the blower tube, and where the inlet portion of the first tube may be rotatably coupled to the portion of the exterior surface of the second tube. Alternatively or additionally, during the air volume mode, the air may be configured to be expelled from an outlet portion of the first tube and an outlet portion of the second tube, and where during the air speed mode, the air may be configured to be expelled from an outlet portion of the second tube. Alternatively or additionally, in the air volume mode, the outlet portion of the first tube may extend over the outlet portion of the second tube at a distance that enables the air to be expelled from the outlet portion of the first tube and the outlet portion of the second tube. Alternatively or additionally, the first tube may include a head portion and a body portion, where the second tube may include a head portion, a body portion, and a shoulder portion, the shoulder portion may include an opening, where the diameter of the head portion of the second tube may be smaller than the diameter of the head portion of the first tube to enable a portion of the air to pass through the opening of the shoulder portion and move around an exterior surface of the second tube to be expelled from the outlet of the first tube. Alternatively or additionally, in order to transition the nozzle portion from the air volume mode to the air speed mode, either of the first tube or the second tube may be translated to enable the outlet portion of the second tube to extend out of the outlet portion of the first tube at a distance to seal off the outlet portion of the first tube such that the air is configured to be expelled only from the outlet portion of the second tube. Alternatively or additionally, the first tube and the second tube may each include a head portion and a body portion, where the head portion of the second tube may be a prolate spheroid shape to enable the outlet portion of the second tube to extend out of the outlet portion of the first tube at the distance to seal off the outlet portion of the first tube. Alternatively or additionally, the first tube may include at least one grooved portion, and the second tube may include at least one projection, and the at least one projection may be disposed in the at least one grooved portion to enable the translation of the first tube or the second tube relative to the other of the first tube or the second tube. Alternatively or additionally, the first tube may include at least one projection, and the second tube may include at least one grooved portion, and the at least one projection may be disposed in the at least one grooved portion to enable the translation of the first tube or the second tube relative to the other of the first tube or the second tube.

### FURTHER EXAMPLES

According to even further examples, there is provided

Example 1. A blower comprising:

a housing;

a motor disposed within a portion of the housing to selectively operate a fan assembly;

a blower tube through which air is forced responsive to operation of the motor, the blower tube comprising:

a body portion; and

a nozzle portion operably coupled to the body portion of the blower tube, wherein the nozzle portion is configured to expel the air from the blower in one of a plurality of modes, the plurality of modes comprising an air speed mode and an air volume mode.

Example 2. The blower of example 1, wherein the nozzle portion comprises a first tube and a second tube, wherein the first tube is coupled to a portion of an exterior surface of the second tube, wherein one of the first tube or the second tube is configured to be translated relative to the other of the first tube or the second tube in order to transition between the air volume mode and the air speed mode.

Example 3. The blower of any of the examples 1-2, wherein the first tube and the second tube each comprise an inlet portion and an outlet portion, wherein the inlet portion of the second tube is operably coupled to the body portion of the blower tube, and wherein the inlet portion of the first tube is rotatably coupled to the portion of the exterior surface of the second tube.

Example 4. The blower of any of the examples 1-3, wherein during the air volume mode, the air is configured to be expelled from an outlet portion of the first tube and an outlet portion of the second tube, and wherein during the air speed mode, the air is configured to be expelled from an outlet portion of the second tube.

Example 5. The blower of any of the examples 1-4, wherein in the air volume mode, the outlet portion of the first tube extends over the outlet portion of the second tube at a distance that enables the air to be expelled from the outlet portion of the first tube and the outlet portion of the second tube.

Example 6. The blower of any of the examples 1-5, wherein the first tube comprises a head portion and a body portion, wherein the second tube comprises a head portion, a body portion, and a shoulder portion, the shoulder portion comprising an opening, wherein the diameter of the head portion of the second tube is smaller than the diameter of the head portion of the first tube to enable a portion of the air to pass through the opening of the shoulder portion and move around an exterior surface of the second tube to be expelled from the outlet of the first tube.

Example 7. The blower of any of the examples 1-6, wherein in order to transition the nozzle portion from the air volume mode to the air speed mode, either of the first tube or the second tube is translated to enable the outlet portion of the second tube to extend out of the outlet portion of the first tube at a distance to seal off the outlet portion of the first tube such that the air is configured to be expelled only from the outlet portion of the second tube.

Example 8. The blower of any of the examples 1-7, wherein the first tube and the second tube each comprise a head portion and a body portion, wherein the head portion of the second tube is a prolate spheroid shape to enable the outlet portion of the second tube to extend out of the outlet portion of the first tube at the distance to seal off the outlet portion of the first tube.

Example 9. The blower of any of the examples 1-8, wherein the first tube comprises at least one grooved portion, and wherein the second tube comprises at least one projection, and wherein the at least one projection is disposed in the at least one grooved portion to enable the translation of the first tube or the second tube relative to the other of the first tube or the second tube.

Example 10. The blower of any of the examples 1-9, wherein the first tube comprises at least one projection, and wherein the second tube comprises at least one grooved portion, and wherein the at least one projection is disposed in the at least one grooved portion to enable the translation of the first tube or the second tube relative to the other of the first tube or the second tube.

Example 11. A nozzle portion for a blower configured to expel air from the blower in one of a plurality of modes, the plurality of modes comprising an air speed mode and an air volume mode, the nozzle portion comprising a first tube and a second tube, wherein the first tube is coupled to a portion of an exterior surface of the second tube, and wherein one of the first tube or the second tube may be translated relative to the other of the first tube or the second tube in order to transition between the air volume mode and the air speed mode.

Example 12. The nozzle portion of example 11, wherein the first tube and the second tube each comprise an inlet portion and an outlet portion, wherein the inlet portion of the second tube is operably coupled to the blower, and wherein the inlet portion of the first tube is rotatably coupled to the portion of the exterior surface of the second tube.

Example 13. The nozzle portion of any of the examples 11-12, wherein the inlet portion of the second tube is operably coupled to a body portion of a tube of the blower.

Example 14. The nozzle portion of any of the examples 11-13, wherein the inlet portion of the first tube is operably coupled to a body portion of a tube of the blower.

Example 15. The nozzle portion of any of the examples 11-14, wherein during the air volume mode, the air is configured to be expelled from an outlet portion of the first tube and an outlet portion of the second tube, and wherein during the air speed mode, the air is configured to be expelled from an outlet portion of the second tube.

Example 16. The nozzle portion of any of the examples 11-15, wherein in the air volume mode, the outlet portion of the first tube extends over the outlet portion of the second tube at a distance that enables the air to be expelled from the outlet portion of the first tube and the outlet portion of the second tube.

Example 17. The nozzle portion of any of the examples 11-16, wherein the first tube comprises a head portion and a body portion, wherein the second tube comprises a head portion, a body portion, and a shoulder portion, the shoulder portion comprising an opening, wherein the diameter of the head portion of the second tube is smaller than the diameter of the head portion of the first tube to enable a portion of the air to pass through the opening of the shoulder portion and move around an exterior surface of the second tube to be expelled from the outlet of the first tube.

Example 18. The nozzle portion of any of the examples 11-17, wherein in order to transition the nozzle portion from the air volume mode to the air speed mode, either of the first tube or the second tube is translated to enable the outlet portion of the second tube to extend out of the outlet portion of the first tube at a distance to seal off the outlet portion of the first tube such that the air is configured to be expelled only from the outlet portion of the second tube.

Example 19. The nozzle portion of any of the examples 11-18, wherein the first tube and the second tube each comprise a head portion and a body portion, wherein the head portion of the second tube is a prolate spheroid shape to enable the outlet portion of the second tube to extend out of the outlet portion of the first tube at the distance to seal off the outlet portion of the first tube.

Example 20. The nozzle portion of any of the examples 11-19, wherein the first tube comprises at least one grooved portion, and wherein the second tube comprises at least one projection, and wherein the at least one projection is disposed in the at least one grooved portion to enable the translation of the first tube or the second tube relative to the other of the first tube or the second tube.

Example 21. The nozzle portion of any of the examples 11-20, wherein the first tube comprises at least one projection, and wherein the second tube comprises at least one grooved portion, and wherein the at least one projection is disposed in the at least one grooved portion to enable the translation of the first tube or the second tube relative to the other of the first tube or the second tube.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

1. A portable leaf blower comprising:
a housing;
a motor disposed within a portion of the housing to selectively operate a fan assembly, and
a blower tube connected to the fan to receive air forced through the blower tube responsive to operation of the motor, the blower tube comprising an adjustable nozzle portion which is reconfigurable between
an air speed mode, in which the nozzle portion is configured to expel the air from the blower at a relatively higher air speed and a relatively lower volumetric flow rate, and
an air volume mode, in which the nozzle portion is configured to expel the air from the blower at a relatively lower air speed and a relatively higher volumetric flow rate, wherein said relatively higher air speed is higher than said relatively lower air speed, and said relatively higher volumetric flow rate is higher than said relatively lower volumetric flow rate.

2. The blower of claim 1, wherein the nozzle portion comprises a first tube and a second tube, wherein one of the first tube and the second tube is configured to be translated relative to the other of the first tube and the second tube in order to transition between the air volume mode and the air speed mode

3. The blower according to claim 2, wherein the second tube extends along a tube axis; the first tube encloses the second tube; and the first and second tubes are movable in relation to each other along said tube axis.

4. The blower according to claim 3, wherein at least one of the first tube and the second tube comprises a tapering tube portion such that, when axially moving the first and second tubes in relation to each other, a radial, with respect to said tube axis, gap between the first and second tubes changes at said tapering tube portion.

5. The blower according to claim 4, wherein each of the first tube and the second tube comprises a respective tapering tube portion, wherein the respective tapering tube portions are in register with each other and taper towards the same axial direction.

6. The blower according to claim 2, further comprising a locking arrangement for locking the position of the second tube relative to the first tube.

7. The blower according to claim 6, wherein the first tube is rotatably coupled to the exterior surface of the second tube to be rotatable about a tube axis between an axially locked position and an axially released position.

8. The blower according to claim 2, wherein during the air volume mode, the air is configured to be expelled from an outlet portion of the first tube and an outlet portion of the second tube, and during the air speed mode, the outlet portion of the first tube is at least partly closed.

9. The blower according to claim 2, wherein in the air volume mode, the outlet portion of the first tube extends over the outlet portion of the second tube at a distance that enables the air to be expelled from the outlet portion of the first tube and the outlet portion of the second tube.

10. The blower according to claim 2, wherein the first tube comprises a head portion and a body portion, wherein the second tube comprises a head portion, a body portion, and a shoulder portion, the shoulder portion comprising an opening, wherein the diameter of the head portion of the second tube is smaller than the diameter of the head portion of the first tube to enable a portion of the air to pass through the opening of the shoulder portion and move around an exterior surface of the second tube to be expelled from the outlet of the first tube.

11. The blower according to claim 2, wherein in order to transition the nozzle portion from the air volume mode to the air speed mode, either of the first tube or the second tube is translated to enable the outlet portion of the second tube to extend out of the outlet portion of the first tube at a distance to seal off the outlet portion of the first tube such that the air is configured to be expelled only from the outlet portion of the second tube.

12. The blower according to claim 2, wherein the first tube and the second tube each comprise a head portion and a body portion, wherein the head portion of the second tube is a prolate spheroid shape configured to enable the outlet portion of the second tube, when in air speed mode, to extend axially out of the outlet portion of the first tube.

13. The blower according to claim 2, wherein one of the first tube and the second tube comprises at least one grooved portion, the other of the first tube and the second tube comprises at least one projection, and the at least one projection is disposed in the at least one grooved portion to enable a guided translation of the first tube or the second tube relative to the other of the first tube and the second tube.

14. The blower according to claim 13, wherein the grooved portion comprises a first groove section extending mainly along a longitudinal direction of the nozzle portion to allow axial translation of the first and second tubes relative to each other, and a second groove section extending mainly in a circumferential direction, to allow rotation of the first and second tubes relative to each other in order to axially lock them together.

15. A nozzle portion for a blower configured to expel air from the blower in one of a plurality of modes, the plurality of modes comprising an air speed mode and an air volume mode, the nozzle portion comprising a first tube and a second tube,
wherein the first tube is coupled to a portion of an exterior surface of the second tube, and
wherein one of the first tube or the second tube may be translated relative to the other of the first tube or the second tube in order to transition between the air volume mode and the air speed mode.
